(19) United States
(12) Patent Application Publication
(10) Pub. No.: US 2025/0291358 A1
(43) Pub. Date: Sep. 18, 2025

(54) DEVICE AND METHOD FOR CONTROLLING MOBLIE ROBOT

(71) Applicant: HL Robotics Co., Ltd., Seongnam (KR)

(72) Inventor: Jaewan AHN, Seongnam (KR)

(21) Appl. No.: 19/077,053

(22) Filed: Mar. 12, 2025

(30) Foreign Application Priority Data
Mar. 12, 2024 (KR) 10-2024-0034295

(51) Int. Cl. G05D 1/622

(52) U.S. Cl. CPC G05D 1/637

(57) ABSTRACT

The present disclosure relates to a mobile robot control device and method. The mobile robot control device according to the present disclosure comprises: a sensor for sensing a path in the traveling direction of the mobile robot; and a controller which includes one or more processors and memories and controls the path or speed of the mobile robot, wherein the controller controls the path or speed of the mobile robot when a blind spot that cannot be sensed by the sensor is detected on the path of the mobile robot, thereby exhibiting the advantages of reducing the risk of collision with an obstacle approaching in a blind spot and optimally controlling the speed and path of the mobile robot.

### CROSS REFERENCE TO RELATED APPLICATION

The present application claims priority to Korean Patent Application No. 10-2024-0034295, filed Mar. 12, 2024, the entire contents of which is incorporated herein for all purposes by this reference.

### BACKGROUND

### Technical Field

The present disclosure relates to a technology for controlling a mobile robot capable of unmanned driving, and particularly to a technology for controlling a driving path or speed of a mobile robot while it is moving.

### Description of the Related Art

Robots are increasingly being used not only in various industrial fields but also in everyday life. The robots are used in factories to assemble products or transport goods, and they are also replacing people in cleaning and serving food at homes and stores.

Such mobile robots are designed to move along a determined path in a limited space while avoiding obstacles. However, when encountering an unexpected obstacle on the path, the mobile robot must be able to stop immediately to prevent collisions, so the speed of the mobile robot is necessarily limited to a certain level or lower.

Research efforts have been made to solve the problem of slowing down the speed of mobile robots of the prior art. A great deal of effort has been made to provide a mobile robot control device and method capable of increasing the speed of a mobile robot by predicting a blind spot that cannot be detected by the mobile robot's sensors, correcting the path of the robot, and adjusting the speed thereof, and as a result.

### SUMMARY

An object of the present disclosure is to enhance the possibility of avoiding collisions with an obstacle approaching in the blind spot of a mobile robot.

Further, another object of the present disclosure is to automatically control the speed and path of the mobile robot according to the possibility of collision.

Meanwhile, other unstated purposes of the present disclosure will be additionally considered within the scope that can be easily inferred from the following detailed description and effects.

A mobile robot control device according to the present disclosure comprises: a sensor configured to sense a path in the traveling direction of the mobile robot; and a controller comprising one or more processors and memories and configured to control the path or speed of the mobile robot, wherein the controller may change the path or speed of the mobile robot when a blind spot that cannot be sensed by the sensor is detected on the path of the mobile robot.

The controller may change the path or speed of the mobile robot according to the size of the blind spot.

The controller may change the path or speed of the mobile robot by determining a virtual obstacle area having the same size as the blind spot on the path of the mobile robot adjacent to the blind spot.

The controller may change the path or speed of the mobile robot to a path that avoids the virtual obstacle area.

The controller may determine the size of the virtual obstacle area corresponding to the blind spot in proportion to the current driving speed of the mobile robot when the blind spot is detected.

The controller may determine the size of the virtual obstacle area corresponding to the blind spot in proportion to the time from when the mobile robot detects an obstacle appearing in the blind spot until it stops when the blind spot is detected.

The time from when the mobile robot detects the obstacle until it stops includes the sum of the time from when the mobile robot detects the obstacle until it starts a stopping operation and the time from when the mobile robot starts the stopping operation until it completely stops.

The controller may reflect a marginal coefficient for adjusting the size of the virtual obstacle area when determining the size of the virtual obstacle area.

The controller may adjust the speed of the mobile robot in inverse proportion to the size of the blind spot when the blind spot is detected.

The controller may create in advance the virtual obstacle area adjacent to the blind spot when it is determined in advance that the blind spot exists on the path of the mobile robot.

A mobile robot control method according to another embodiment of the present disclosure may comprise:
sensing a path in the traveling direction of the mobile robot by a sensor; and changing the path or speed of the mobile robot when a blind spot that cannot be sensed by the sensor is detected on the path.

The changing the path or speed of the mobile robot may include changing the path or speed of the mobile robot according to the size of the blind spot.

The changing the path or speed of the mobile robot may include changing the path or speed of the mobile robot by determining a virtual obstacle area having the same size as the blind spot on the path of the mobile robot adjacent to the blind spot.

The changing the path or speed of the mobile robot may include changing the path of the mobile robot to a path that avoids the virtual obstacle area.

The changing the path or speed of the mobile robot may include determining the size of the virtual obstacle area corresponding to the blind spot in proportion to the current driving speed of the mobile robot when the blind spot is detected.

The changing the path or speed of the mobile robot may include determining the size of the virtual obstacle area corresponding to the blind spot in proportion to the time from when the mobile robot detects an obstacle appearing in the blind spot until it stops when the blind spot is detected.

The time from when the mobile robot detects an obstacle until it stops includes the sum of the time from when the mobile robot detects the obstacle until it starts a stopping operation and the time from when the mobile robot starts the stopping operation until it completely stops.

A marginal coefficient for adjusting the calculated size of the virtual obstacle area may be reflected when determining the size of the virtual obstacle area.

The changing the path or speed of the mobile robot may include adjusting the speed of the mobile robot in inverse proportion to the size of the blind spot when the blind spot is detected.

The changing the path or speed of the mobile robot may include creating in advance the virtual obstacle area adjacent to the blind spot when it is determined in advance that the blind spot exists on the path of the mobile robot.

According to the present disclosure, there is an effect of effectively controlling the driving path or speed of a mobile robot.

In addition, there is also the advantage of lowering the possibility of collision with an obstacle approaching in a blind spot due to the obstacle existing in the path of the mobile robot.

Meanwhile, it is to be added that even if not explicitly mentioned herein, the effects described in the following specification and their potential effects expected from the technical features of the present disclosure are treated as if described in the specification of the present disclosure.

### BRIEF DESCRIPTION OF THE DRAWINGS

FIG. 1 is a schematic structural diagram of a mobile robot control device according to a preferred embodiment of the present disclosure.

FIG. 2 shows an example of the sensing range of a mobile robot according to a preferred embodiment of the present disclosure.

FIG. 3 shows a change in a blind spot as a mobile robot according to a preferred embodiment of the present disclosure moves.

FIGS. 4 (a)˜(c) show an example of controlling the path of a mobile robot according to a change in a blind spot according to a preferred embodiment of the present disclosure.

FIG. 5 shows an example of determining a virtual obstacle area according to a preferred embodiment of the present disclosure.

FIGS. 6 (a) and (b) show an example of determining a virtual obstacle area in proportion to the driving speed of a mobile robot according to a preferred embodiment of the present disclosure.

FIG. 7 shows an example of determining a virtual obstacle area according to a preferred embodiment of the present disclosure.

FIGS. 8 (a)˜(d) show a change in a blind spot according to the position of a mobile robot and the sensing range of a sensor unit thereof according to a preferred embodiment of the present disclosure.

FIGS. 9 (a)˜(c) show a relationship between a blind spot and a virtual obstacle area according to a preferred embodiment of the present disclosure.

FIG. 10 is a schematic flowchart of a mobile robot control method according to another preferred embodiment of the present disclosure.

It is noted that the attached drawings are illustrated as reference for understanding the technical idea of the present disclosure, and the scope of the present disclosure is not limited thereto.

### DETAILED DESCRIPTION

The above objects, means, and resulting effects of the present disclosure will become more apparent through the following detailed description in conjunction with the attached drawings, and thus those skilled in the art may easily implement the technical idea of the present disclosure. In addition, in describing the present disclosure, if it is determined that detailed descriptions of the known technology related to the present disclosure may unnecessarily obscure the gist of the present disclosure, the detailed description thereof will be omitted.

The terms used in the specification are for describing embodiments and are not intended to limit the present disclosure. In the specification, singular forms also include plural forms in some cases unless specifically stated otherwise in the context. In the specification, terms such as “include”, “be provided with”, or “have” do not preclude the existence or addition of one or more other components other than the mentioned components.

In the specification, terms such as “or”, “at least one”, and the like may indicate one of words listed together, or a combination of two or more. For example, “A or B”, “at least one of A and B” may include only one of A and B, or both A and B.

In the specification, descriptions following “for example” or the like may not accurately match the information presented, such as cited characteristics, variables, or values, and should not limit embodiments of the present disclosure according to various embodiments of the present disclosure by effects such as variations, including tolerance, measurement error, measurement accuracy limits, and other commonly known factors.

When a component is referred to as being “connected” or “coupled” to another component, it should be understood that although they may be directly connected or coupled to each other, other components may exist in the middle. On the other hand, when a component is referred to as “directly connected” or “directly coupled” to another component, it should be understood that no other component exists in the middle.

In the specification, when it is stated that a component is ‘on’ or‘in contact’ with another component, it should be understood that another component may exist in the middle, although it may be in direct contact with or connected to the other component. On the other hand, if a component is described as being ‘right above’ or ‘in direct contact’ with another component, it can be understood that there is no other component in the middle. Other expressions that describe the relationship between components, for example, ‘between’ and ‘directly between’ can also be interpreted in the same way.

In the specification, terms such as ‘first’ and ‘second’ may be used to describe various components, but these components should not be limited by the above terms. In addition, the above terms should not be interpreted as limiting the order of each component and may be used to distinguish one component from another. For example, a ‘first component’ may be referred to as a ‘second component’, and similarly, a ‘second component’ may be referred to as a ‘first component’.

If there is no other definition, all terms used in the specification may be used as meanings commonly understood by those skilled in the art to which the present disclosure belongs. Additionally, terms defined in commonly used dictionaries are not interpreted ideally or excessively unless clearly specifically defined.

Hereinafter, exemplary embodiments according to the present disclosure will be described in detail with reference to the accompanying drawings.

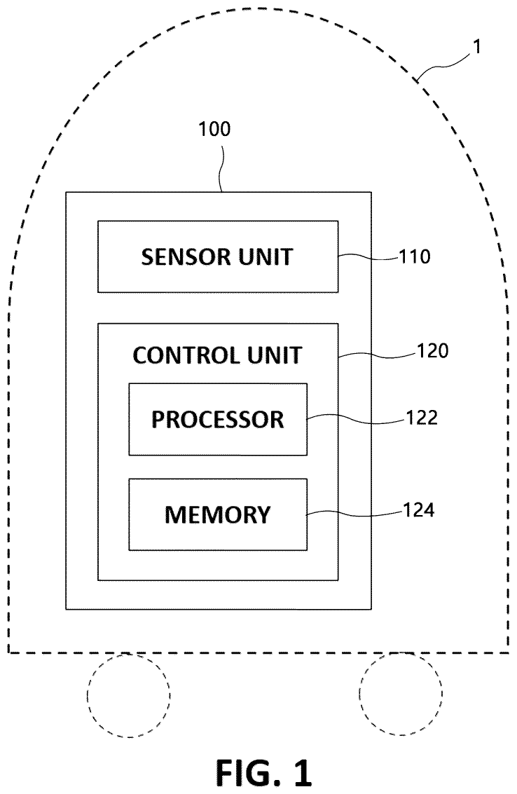

FIG. 1 is a schematic structural diagram of a mobile robot control device according to a preferred embodiment of the present disclosure.

The mobile robot control device 100 according to the present disclosure controls the path or speed of the mobile robot 1 by sensing obstacles or corners on the path.

To this end, the mobile robot control device 100 may include a sensor unit 110 and a controller 120.

The sensor unit 110 is configured to sense various obstacles in the path of the mobile robot 1.

To this end, the sensor unit 110 may include various sensors such as a LiDAR sensor, a RADAR sensor, and a camera.

In the case of static obstacles such as walls or pillars, it will be possible to prepare for them by grasping them in advance using map data, etc. in the process of generating path information for the movement of the mobile robot 1. However, since dynamic obstacles vary in type, form, and speed, the mobile robot 1 must drive while considering the possibility of collisions with dynamic obstacles detected by the sensor unit 110.

A blind spot is generated in the sensing area of the sensor due to static obstacles (pillars, corners) while the mobile robot 1 is moving. Since the risk of collision increases when the dynamic obstacle suddenly appears in such a blind spot, the controller 120 controls the driving path or speed of the mobile robot 1 to prepare for such a situation.

To this end, the controller 120 may include one or more processors 122 and memories 124.

The memory 124 stores several types of information necessary for the operation of the mobile robot control device 100. The storage information of the memory 124 may include surrounding environment information sensed by the sensor unit 110, information for a control operation of the controller 120, information processed and analyzed by the controller 120, program information related to a control method to be described later, and the like, but is not limited thereto.

For example, depending on the type, the memory 124 may include a hard disk type, a magnetic media type, a compact disk read only memory (CD-ROM), an optical media type, a magneto-optical media type, a multimedia card micro type, a flash memory type, a read only memory type, or a random access memory type, etc., but is not limited thereto. In addition, the memory 124 may be a cache memory, a buffer, a main memory unit, an auxiliary storage or a separately provided storage system depending on its use/location, but is not limited thereto.

The controller 120 can perform various control operations for the mobile robot control device 100. That is, the controller 120 may control the sensor unit 110, may control the processing and analysis of information sensed through the communication unit 110, and may control the execution of a control method to be described later. For example, the controller 120 may include a processor 122 as hardware or a process as software performed by the processor 122, but is not limited thereto.

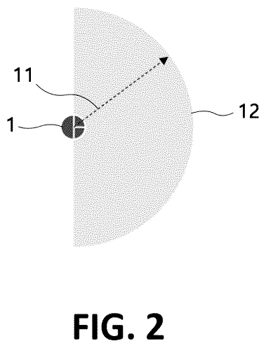

FIG. 2 shows an example of the sensing range of a mobile robot according to a preferred embodiment of the present disclosure.

The sensor unit 110 of the mobile robot 1 is capable of sensing a certain sensing distance 11 depending on the performance of the sensor, and has a semicircular sensing range 12 when sensing is possible up to 180 degrees left and right.

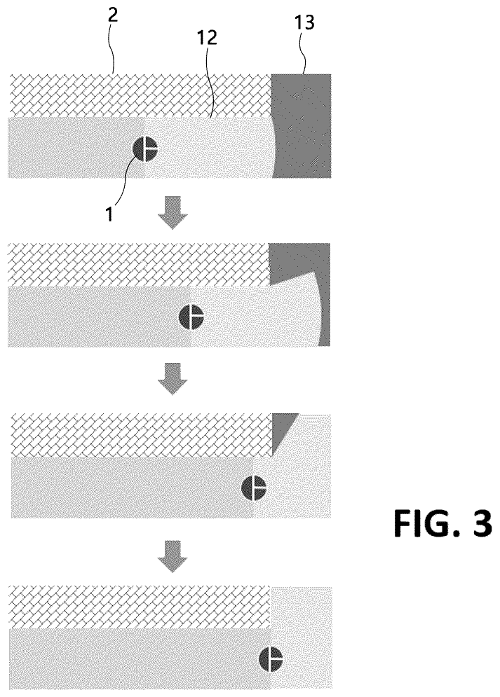

FIG. 3 shows a change in a blind spot as a mobile robot according to a preferred embodiment of the present disclosure drives.

When the mobile robot 1 moves along its driving path, it may encounter obstacles 2 such as walls or pillars. A blind spot 13 that cannot be sensed by the sensor unit 110 is generated by such a wall or pillar, gradually decreases as the mobile robot 1 moves, and disappears when it reaches the corner of the wall.

Therefore, the controller 120 of the mobile robot control device 100 according to the present disclosure controls the speed or path of the mobile robot 1 according to the driving speed of the mobile robot 1 and the size of the blind spot 13.

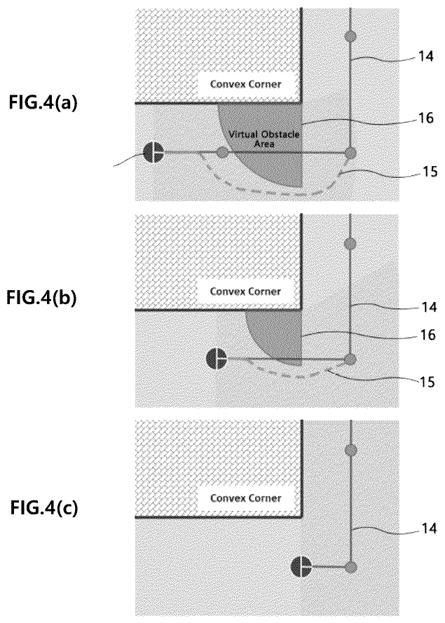

FIG. 4 shows an example of controlling the path of a mobile robot according to a change in a blind spot according to a preferred embodiment of the present disclosure.

When a blind spot occurs on the driving path of the mobile robot 1, the controller 120 may generate a virtual obstacle area in proportion to the size of the blind spot and modify the path of the mobile robot 1 to a path that avoids it. Also, it is possible to control the driving speed of the mobile robot 1 to be slower than when there is no obstacle. To this end, the controller 120 may determine the virtual obstacle area on the path of the mobile robot 1 adjacent to the blind spot.

In FIG. 4A, when the mobile robot 1 is far from the corner of the obstacle, the size of the blind spot behind the obstacle increases.

The controller 120 determines the virtual obstacle area 16 in proportion to the size of the blind spot, and controls (changes) the path of the mobile robot 1 to a path 15 that avoids the virtual obstacle area 16 instead of the originally determined driving path 14.

In FIG. 4B, when the mobile robot 1 is not far from the corner of the obstacle, the size of the blind spot behind the obstacle is relatively reduced.

Accordingly, the controller 120 determines the virtual obstacle area 16 as small as the reduced blind spot and controls the path of the mobile robot 1 to the avoidance path 15. In this case, the avoidance path 15 bypasses the corner portion of the obstacle to a smaller extent than in the case of FIG. 4C.

As shown in FIG. 4C, when the mobile robot 1 reaches the corner of the obstacle, the blind spot disappears, so the mobile robot 1 returns to the originally determined driving path 14 and continues moving.

Alternatively, the controller 120 may control the speed of the mobile robot 1 instead of its path according to the size of the blind spot.

When the blind spot is large as shown in FIG. 4A, that is, when the virtual obstacle area is large, the speed of the mobile robot 1 may be controlled to be slow. When the blind spot is small as shown in FIG. 4B, that is, when the virtual obstacle area is small, the speed of the mobile robot 1 may be controlled to be faster than that of FIG. 4A and slower than the original speed.

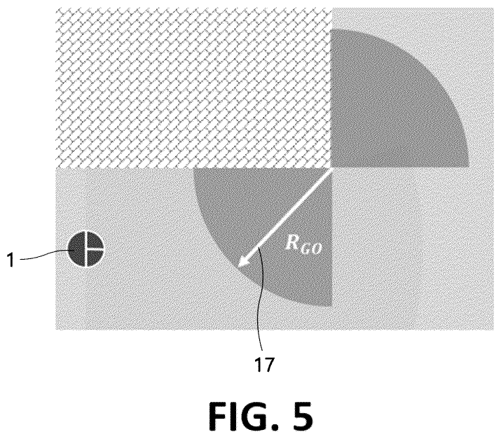

FIG. 5 shows an example of determining the virtual obstacle area according to a preferred embodiment of the present disclosure.

The virtual obstacle area may be formed in the shape of a fan with a radius of R_{GO}(R_{GhostObstacle}) 17 at the corner of the obstacle.

The controller 120 may calculate the radius 17 of the virtual obstacle area as shown in the following equation:

$${R}_{GhostObstacl e} = f ( {d}_{delay} , {d}_{braking} , {kv}_{robot} , {d}_{marginal} )$$

That is, the radius of the virtual obstacle area, R_{GhostObstacle} may be expressed as a function of d_{delay}, d_{braking}, kv_{robot}, and d_{marginal}.

The d_{delay} is a distance that the mobile robot 1 moves during the calculation time from when it detects an obstacle until when it generates a stop signal and starts a stopping operation (braking). That is, it is the distance moved during the delay time from when the mobile robot 1 responds to the obstacle until it starts the stopping operation.

The d_{braking} is a distance that the mobile robot 1 moves during the time from when it actually starts the stopping operation until it comes to a complete stop. That is, it means the braking distance of the mobile robot 1.

The k is a proportional coefficient related to v_{robot}, a driving speed of the mobile robot 1. The k may be determined according to the user's determining.

The d_{marginal} is a marginal coefficient for adjusting the size of the radius of the virtual obstacle area determined using d_{delay}, d_{braking}, and kv_{robot}. That is, it is a coefficient for applying a marginal value to the size of the calculated virtual obstacle area, which may be adjusted directly by the user or determined to an optimal value through repeated driving tests.

In this way, the controller 120 calculates the radius 17 of the virtual obstacle area using the speed of the mobile robot 1, the distance related to braking, and the like.

Specifically, the ddelay may be obtained as the product of the speed of the mobile robot 1 (v_{robot}) and the delay time (t_{delay}) as in the following equation:

$${d}_{delay} = {v}_{robot} * {t}_{delay}$$

wherein t_{delay} is the delay time from the detection of an obstacle to the start of the stopping operation, and can be obtained as the sum of t_{sensing}, t_{signal}, and t_{control} as follows:

$${t}_{delay} = {t}_{sensing} + {t}_{signal} + {t}_{control}$$

wherein t_{sensing} is the time it takes for the sensor signal to be output from the sensor unit 110 and then reflected by the obstacle to return.

The t_{signal} is the time taken from when the obstacle is detected by the sensor unit 110 until a stop signal is output from the controller 120.

The t_{control} is the time taken from when the stop signal is output from the controller 120 until it is transmitted to the brake actuator of the mobile robot 1 and the stopping operation actually begins.

The d_{braking} is the braking distance that the mobile robot 1 moves during the time from when it starts the stopping operation until it comes to a complete stop, and can be obtained as half of the product of the speed of the mobile robot 1 (v_{robot}) and the time it takes to stop (d_{braking}) as follows:

$${d}_{braking} = {v}_{robot} * \frac{1}{2} {t}_{braking}$$

wherein t_{braking} is the time taken from when the mobile robot 1 starts the stopping operation until it comes to a complete stop, and is a value obtained by subtracting the braking start time (t_{braking_start}) from the braking end time (t_{braking_end}) as follows:

$${t}_{braking} = {t}_{braking\_end} - {t}_{braking\_start}$$

wherein k is a proportional coefficient related to the driving speed of the mobile robot 1. The k may be determined according to the user's determining.

Therefore, the virtual obstacle area becomes larger as the speed of the mobile robot 1 increases and the braking distance becomes longer (i.e., the braking time becomes longer).

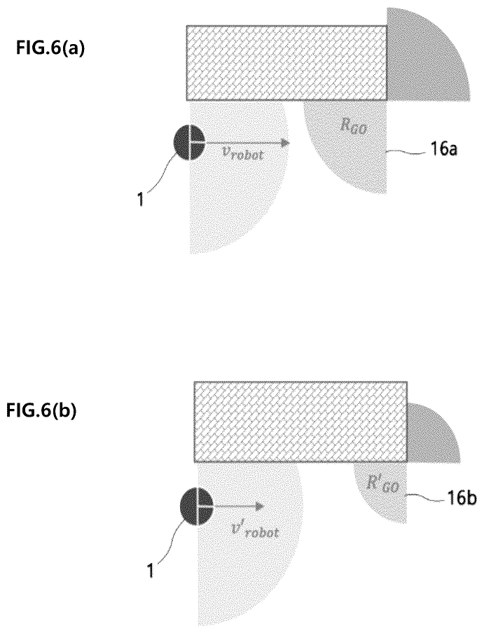

FIG. 6 shows an example of determining the virtual obstacle area in proportion to the driving speed of the mobile robot according to a preferred embodiment of the present disclosure.

As the driving speed (v_{robot}) of the mobile robot 1 increases, the braking distance of the mobile robot 1 increases. Therefore, to prevent collisions with moving obstacles, the size of the virtual obstacle area should be determined in proportion to the driving speed of the mobile robot 1.

FIG. 6A is a case where the speed of the mobile robot 1 is high, and FIG. 6B is a case where the speed is relatively slow compared to FIG. 6A.

Accordingly, the virtual obstacle area 16a of in FIG. 6A may be determined to be larger than the virtual obstacle area 16b in FIG. 6A. Here, k is a proportional constant that can be determined by the user.

As described above, the virtual obstacle area can be determined according to the driving speed and braking characteristics of the mobile robot 1, thereby reducing the possibility of collisions with the moving obstacles.

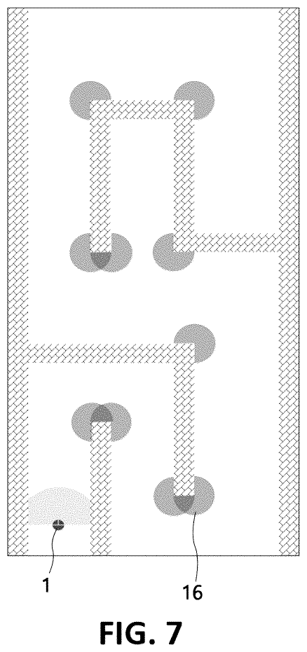

FIG. 7 shows an example of determining the virtual obstacle area according to a preferred embodiment of the present disclosure.

The virtual obstacle area exists in the same size as the blind spot at each corner on the driving path of the mobile robot 1.

When map information about the driving path of the mobile robot 1 is provided, the location of each corner can be determined before start moving, and thus the size of the virtual obstacle area can also be created in advance.

To this end, the mobile robot control device 100 according to the present disclosure may further include a communication unit (not shown) for receiving map information.

The communication unit is configured to receive map information from a server or the like storing the map information.

For example, the communication unit can perform wireless communication such as 5G (5th generation communication), LTE-A (long term evolution-advanced), LTE (long term evolution), Bluetooth, BLE (Bluetooth low energy), NFC (near field communication), Wi-Fi communication, or wired communication such as cable communication, but is not limited thereto.

The blind spots and virtual obstacle areas may be determined at all corners on the map by the received map information, but when the path of the mobile robot 1 is determined, unnecessary computations of the controller 120 may be reduced by determining them only for corners existing on the path.

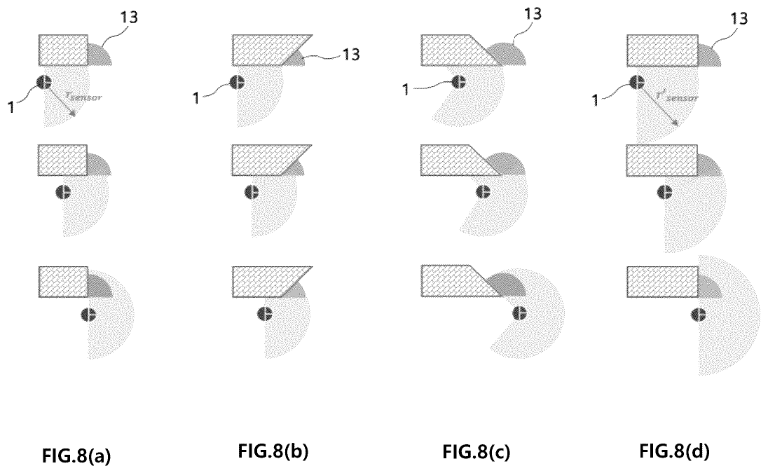

FIG. 8 shows a change in the blind spot according to the position of the mobile robot and the sensing range of the sensor unit thereof according to a preferred embodiment of the present disclosure.

FIG. 8A shows an example in which the angle of the obstacle corner is 90 degrees and the sensing angle of the sensor unit 110 is 180 degrees.

In this case, it can be confirmed that the blind spot 13 gradually decreases until the mobile robot 1 reaches the corner.

FIG. 8B shows an example in which the angle of the obstacle corner is greater than 90 degrees and the sensing angle of the sensor unit 110 is still 180 degrees.

In this case, since the angle of the obstacle corner is greater than 90 degrees, the size of the blind spot becomes smaller than when the angle of the corner is 90 degrees. Accordingly, it can be confirmed that the blind spot has already disappeared when the mobile robot 1 is located on an extension line from the corner before reaching the corner.

FIG. 8C shows an example in which the angle of the obstacle corner is less than 90 degrees and the sensing angle of the sensor unit 110 is greater than 180 degrees.

In this case, since the angle of the obstacle corner is less than 90 degrees, the size of the blind spot becomes larger than in the previous cases. Therefore, the blind spot disappears only after the mobile robot 1 passes the corner. If the sensing angle of the sensor unit 110 is 180 degrees, the blind spot will still exist after passing the corner.

FIG. 8D shows an example of a case in which the angle of the obstacle corner is 90 degrees and the sensing angle of the sensor unit 110 is also 180 degrees, but the sensor sensing distance is longer.

When the sensing distance of the sensor unit 110 is longer, the number of cases in which some of the blind spots can be detected increases, so the blind spots can be reduced compared to the case in FIG. 8D.

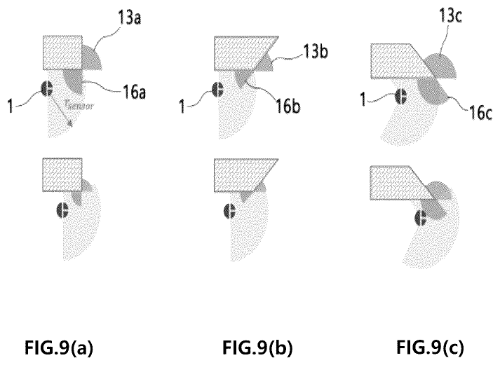

FIG. 9 shows a relationship between the blind spot and the virtual obstacle area according to a preferred embodiment of the present disclosure.

FIG. 9A shows the case where the corner angle of the obstacle is 90 degrees, FIG. 9B shows the case where the corner angle is greater than 90 degrees, and FIG. 9C shows the case where the corner angle is less than 90 degrees.

The size of the virtual obstacle area is determined equal to the size of the blind spot. Therefore, the central angle of the fan shape of the virtual obstacle area 16 is equal to that of the blind spot 13, which is 180 degrees minus the corner angle.

Accordingly, the angle of the blind spot 13a and the angle of the virtual obstacle area 16a in FIG. 9A are 90 degrees; the angle of the blind spot 13b and the angle of the virtual obstacle area 16b in FIG. 9B are acute angles less than 90 degrees; and the angle of the blind spot 13c and the angle of the virtual obstacle area 16c in FIG. 9C are obtuse angles greater than 90 degrees.

In addition, the size (radius) of the virtual obstacle area 13 is reduced by the ratio of the sensing area of the sensor unit 110 from the size of the blind spot. This can be expressed as the following equation:

$${R}_{Ghost\_Obstacle} = \frac{{R}_{Blind\_Spot} - {R}_{Sensing}}{{R}_{Blind\_Spot}}$$

In this way, by determining the virtual obstacle area according to the size of the blind spot of the sensor unit 110 of the mobile robot 1 and to control the path or speed of the mobile robot 1, it is possible to reduce the possibility of collisions with a moving obstacle that suddenly appears in the blind spot

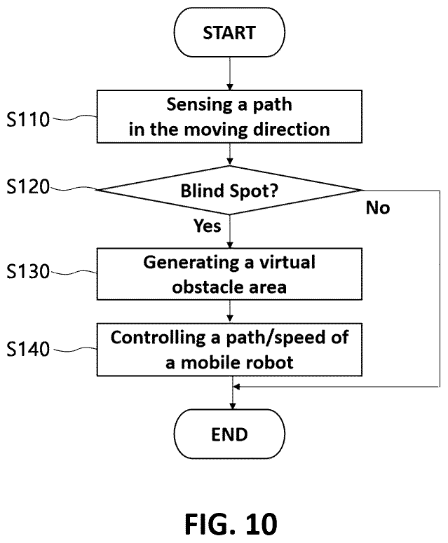

FIG. 10 is a flowchart of a mobile robot control method according to another preferred embodiment of the present disclosure.

The mobile robot control method according to the present disclosure may be performed by the controller including one or more processors and memories.

First, the path in the moving direction of the mobile robot is sensed using the sensor unit (S110).

The sensor unit may include a LiDAR sensor, a RADAR sensor, a camera, or the like.

As a result of the sensing, it is determined whether a blind spot exists within the sensing range (S120), and if the blind spot exists, a virtual obstacle area corresponding thereto is generated (S130).

The blind spot is generated in the sensing area of the sensor due to static obstacles (pillars, corners) while the mobile robot is moving. Since the risk of collision increases when the dynamic obstacle suddenly appears in such a blind spot, the controller detects the blind spot to prepare for such a situation.

When a blind spot is generated by static obstacles such as pillars or corners, a virtual obstacle area with the same size as the blind spot is created at the corner of the blind static obstacles.

The parts that should be considered in determining up the virtual obstacle area are as discussed above. For example, the size of the virtual obstacle area may be determined in proportion to the current driving speed, braking distance, or braking time of the mobile robot. In this case, the braking time can be calculated as the sum of the delay time from when the mobile robot detects the obstacle until it starts a stopping operation and the time from when it starts the stopping operation until it completely stops.

In another embodiment, the virtual obstacle area may be determined in advance on the path of the mobile robot according to map information previously received by the mobile robot. In such a case, there is an advantage in that the amount of calculation of the controller can be reduced.

When the virtual obstacle area is created, the traveling path of the mobile robot is adjusted or the traveling speed is controlled accordingly (S140).

The path or speed of the mobile robot can be controlled according to the size of the determined virtual obstacle area.

That is, the path of the mobile robot can be adjusted in a direction to avoid the virtual obstacle area depending on the size thereof, or the speed of the mobile robot can be controlled to be slower as the size of the virtual obstacle area becomes larger.

As described above, according to the mobile robot control device and method in accordance with the present disclosure, there is an effect of reducing the possibility of collisions with a moving obstacle approaching in a blind spot created by an obstacle existing on the path of the mobile robot.

Although specific embodiments have been described in the detailed description of the disclosure, it goes without saying that various modifications can be made without departing from the scope of the present disclosure. Therefore, the scope of the present disclosure is not limited to the described embodiments, and should be defined by the claims described below and their equivalents.

What is claimed is:

1. A mobile robot control device, the device comprising:
a sensor configured to sense a path in the traveling direction of the mobile robot; and
a controller comprising one or more processors and memories and configured to control the path or speed of the mobile robot,
wherein the controller is configured to change the path or speed of the mobile robot when a blind spot that cannot be sensed by the sensor is detected on the path of the mobile robot.

2. The device of claim 1, wherein the controller is configured to change the path or speed of the mobile robot according to the size of the blind spot.

3. The device of claim 1, wherein the controller is configured to change the path or speed of the mobile robot by determining a virtual obstacle area having the same size as the blind spot on the path of the mobile robot adjacent to the blind spot.

4. The device of claim 3, wherein the controller is configured to change the path or speed of the mobile robot to a path that avoids the virtual obstacle area.

5. The device of claim 3, wherein the controller is configured to determine the size of the virtual obstacle area corresponding to the blind spot in proportion to the current driving speed of the mobile robot when the blind spot is detected

6. The device of claim 3, wherein the controller is configured to determine t the size of the virtual obstacle area corresponding to the blind spot in proportion to the time from when the mobile robot detects an obstacle appearing in the blind spot until it stops when the blind spot is detected.

7. The device of claim 6, wherein the time from when the mobile robot detects the obstacle until it stops includes the sum of the time from when the mobile robot detects the obstacle until it starts a stopping operation and the time from when the mobile robot starts the stopping operation until it completely stops.

8. The device of claim 5, wherein the controller is configured to reflect a marginal coefficient for adjusting the size of the virtual obstacle area when determining the size of the virtual obstacle area.

9. The device of claim 1, wherein the controller is configured to adjust the speed of the mobile robot in inverse proportion to the size of the blind spot when the blind spot is detected.

10. The device of claim 3, wherein the controller is configured to create in advance the virtual obstacle area adjacent to the blind spot when it is determined in advance that the blind spot exists on the path of the mobile robot.

11. A mobile robot control method performed by a controller including one or more processors and memories, the method comprising:
sensing a path in the traveling direction of the mobile robot by a sensor; and
changing the path or speed of the mobile robot when a blind spot that cannot be sensed by the sensor is detected on the path.

12. The method of claim 11, wherein the changing the path or speed of the mobile robot includes changing the path or speed of the mobile robot according to the size of the blind spot.

13. The method of claim 11, wherein the changing the path or speed of the mobile robot includes changing the path or speed of the mobile robot by determining a virtual obstacle area having the same size as the blind spot on the path of the mobile robot adjacent to the blind spot.

14. The of claim 13, wherein the changing the path or speed of the mobile robot includes changing the path of the mobile robot to a path that avoids the virtual obstacle area.

15. The of claim 13, wherein the changing the path or speed of the mobile robot includes determining the size of the virtual obstacle area corresponding to the blind spot in proportion to the current driving speed of the mobile robot when the blind spot is detected.

16. The of claim 13, wherein the changing the path or speed of the mobile robot includes determining the size of the virtual obstacle area corresponding to the blind spot in proportion to the time from when the mobile robot detects an obstacle appearing in the blind spot until it stops when the blind spot is detected.

17. The of claim 16, wherein the time from when the mobile robot detects an obstacle until it stops includes the sum of the time from when the mobile robot detects the obstacle until it starts a stopping operation and the time from when the mobile robot starts the stopping operation until it completely stops.

18. The of claim 15, wherein a marginal coefficient for adjusting the calculated size of the virtual obstacle area is reflected when determining the size of the virtual obstacle area.

19. The of claim 11, wherein the changing the path or speed of the mobile robot includes adjusting the speed of the mobile robot in inverse proportion to the size of the blind spot when the blind spot is detected.

20. The method of claim 13, wherein the changing the path or speed of the mobile robot includes creating in advance the virtual obstacle area adjacent to the blind spot when it is determined in advance that the blind spot exists on the path of the mobile robot.
